(19) United States
(12) Patent Application Publication
(10) Pub. No.: US 2026/0118846 A1
(43) Pub. Date: Apr. 30, 2026

(54) NUMERICAL CONTROL DEVICE

(71) Applicant: Mitsubishi Electric Corporation, Tokyo (JP)

(72) Inventor: Masakazu SAGASAKI, Tokyo (JP)

(73) Assignee: Mitsubishi Electric Corporation, Tokyo (JP)

(21) Appl. No.: 19/142,965

(22) PCT Filed: Mar. 15, 2023
(86) PCT No.: PCT/JP2023/009995

§ 371 Date: Jun. 25, 2025

(51) Int. Cl. G05B 19/18

(52) U.S. Cl. CPC G05B 19/182; G05B 2219/41279; G05B 2219/49074

(57) ABSTRACT

A numerical control device disclosed herein, which controls a servo motor and a brake device for braking the servo motor to cause a machine tool to execute vibration cutting, includes an estimation unit to estimate deterioration of the brake device on the basis of a number of cycles of micro vibrations associated with the vibration cutting.

### TECHNICAL FIELD

The present disclosure relates to a numerical control device which controls vibration cutting.

### BACKGROUND TECHNOLOGY

A servo motor controlled by a numerical control device is usually equipped with a brake device to prevent, for example, a feeder movable in a vertical direction from falling when the power is turned off. The parts which make up the brake device are worn out by repeated use of brake operation, etc., and the wear of these parts brings the brake device to the end of its operating life. For this reason, it is important to recognize in advance the deterioration and operating life expectancy of the brake device and to be well prepared for its malfunction and unexpected failure.

Various techniques have been proposed for recognizing the deterioration of the brake device. For example, Patent Document 1 discloses a technique for monitoring the operating life of an electromagnetic brake on the basis of the total workload of the electromagnetic brake, which is obtained by calculating a workload of the electromagnetic brake and summing it for each braking operation performed to cause the machine tool to make an emergency stop.

### PRIOR ART REFERENCES

### Patent Documents

[Patent Document 1] Japanese Unexamined Patent Application Publication No. 2006-155199

### SUMMARY OF INVENTION

### Problem to be Solved by the Invention

However, the effect of Patent Document 1 above is limited to monitoring the deterioration caused by brake operation. For example, in a machine tool which performs vibration cutting, it is not possible to recognize the deterioration caused by the vibration cutting in a fastening hub which is worn by the vibration of the vibration cutting or in a brake device which includes a friction plate, etc. as parts.

The present disclosure is made in view of the above circumstances and is intended to provide a numerical control device with the capability to recognize the deterioration caused by vibration cutting in a brake device which brakes a servo motor.

### Means for Solving the Problems

The numerical control device according to the present disclosure controls a servo motor and a brake device for braking the servo motor to cause a machine tool to execute vibration cutting. In order to achieve the above objective, the numerical control device is provided with an estimation unit to estimate deterioration of the brake device on the basis of a number of cycles of micro vibrations associated with the vibration cutting.

### Effect of the Invention

According to the present disclosure, it is possible to provide a numerical control device with the capability to recognize the deterioration caused by vibration cutting in a brake device which brakes a servo motor.

### BRIEF DESCRIPTION OF DRAWINGS

FIG. 1 shows a configuration example of a numerical control device according to the embodiment.

FIG. 2 illustrates an implementation example of a brake device according to the embodiment.

FIG. 3 illustrates an operation of the brake device according to the embodiment.

FIG. 4 illustrates an example of a structure of a fastening hub of the brake device according to the embodiment.

FIG. 5 shows an example of a process performed by the numerical control device according to the embodiment.

FIG. 6 illustrates an example of information according to the embodiment showing the relationship between the execution time of vibration cutting and the wear amount in the fastening hub provided in the brake device.

FIG. 7 shows an example of a screen display outputted by the numerical control device according to the embodiment.

FIG. 8 shows operating conditions of vibration cutting control according to the embodiment.

FIG. 9 schematically shows an example of vibration waveforms before and after change of the operating conditions for the vibration cutting control according to the embodiment.

FIG. 10 shows another example of the screen display outputted by the numerical control device according to the embodiment.

FIG. 11 shows a configuration example of a numerical control device according to a modification.

FIG. 12 shows an example of a process performed by the numerical control device according to the modification.

FIG. 13 illustrates an operation of a brake device according to an alternative embodiment.

FIG. 14 shows a hardware configuration example of a control computation unit according to the embodiment and the modification.

### EMBODIMENT FOR CARRYING OUT THE INVENTION

The following is a detailed description of a numerical control device according to the embodiment with reference to the drawings. Note that the present invention is not limited by the embodiments.

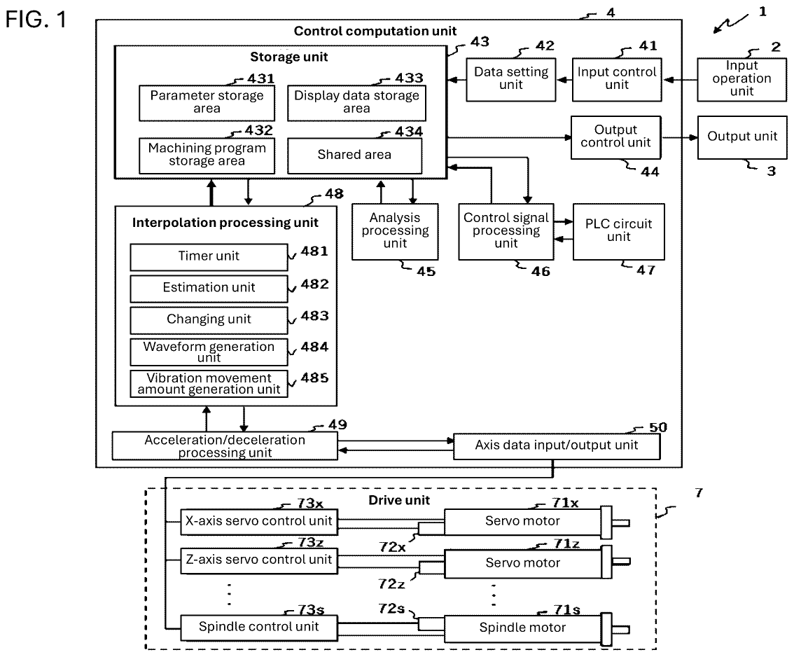

FIG. 1 is a block diagram showing an example of a numerical control device 1 according to the embodiment. The numerical control (NC) device 1 shown in FIG. 1 is, for example, a computer which performs the control of vibration cutting, which is a machining operation performed by vibrating a tool bit in a machine tool which performs the cutting operation. The numerical control device 1 includes an input operation unit 2, an output unit 3, and a control computation unit 4. Also shown in FIG. 1, for example, is a drive unit 7, which is a component of the machine tool. Note that the drive unit 7 may be a separate component from the machine tool.

The drive unit 7, connected to the control computation unit 4, is a mechanism which drives at least one of the tool bit for machining a workpiece, which is the target of machining of the machine tool, and the workpiece. In the present embodiment, the drive unit 7 is, for example, a mechanism for machining a workpiece by rotating the workpiece and driving the tool bit in two directions: one parallel to the X-axis direction and the other parallel to the Z-axis direction. The X-axis direction is, for example, the vertical direction, in other words, the direction of gravity. The Z-axis direction is, for example, the horizontal direction. In the present embodiment, the central axis line of the workpiece is defined as the Z-axis and the direction perpendicular to the Z-axis is defined as the X-axis. The axial directions are not limited to the above directions because they depend on the machine configuration.

The drive unit 7 includes an X-axis servo motor 71x, a detector 72x, and an X-axis servo control unit 73x. The X-axis servo motor 71x moves the tool bit in the X-axis direction defined in the numerical control device 1. The detector 72x detects the position and velocity of the X-axis servo motor 71x. The X-axis servo control unit 73x performs feedback control of the X-axis servo motor 71x on the basis of the command from the numerical control device 1 as well as position information and velocity information detected by the detector 72x. When mentioning about feedback control, the term feedback may also be abbreviated as FB in the following. The X-axis servo control unit 73x realizes the movement of the tool bit in the X-axis direction by performing FB control of the X-axis servo motor 71x. The drive unit 7 outputs the position information detected by the detector 72x to the control computation unit 4 as an FB vibration movement amount on the X axis.

The drive unit 7 also includes a Z-axis servo motor 71z, a detector 72z, and a Z-axis servo control unit 73z. The Z-axis servo motor 71z moves the tool bit in the Z-axis direction defined in the numerical control device 1. The detector 72z detects the position and velocity of the Z-axis servo motor 71z. The Z-axis servo control unit 73z performs the FB control of the Z-axis servo motor 71z on the basis of the command from the numerical control device 1 as well as position information and velocity information detected by the detector 72z. The Z-axis servo control unit 73z controls the operation of the tool bit in the Z-axis direction by performing the FB control of the Z-axis servo motor 71z. The drive unit 7 outputs position information detected by the detector 72z to the control computation unit 4 as an FB vibration movement amount on the Z axis.

Note that the machine tool may have one or more tool bit holders. In the case of a machine tool with two or more tool bit holders, the drive unit 7 includes, per tool bit holder, two or more sets of the X-axis servo motor 71x, the detector 72x, and the X-axis servo control unit 73x as well as the Z-axis servo motor 71z, the detector 72z, and the Z-axis servo control unit 73z.

The drive unit 7 also includes a spindle motor 71s, a detector 72s, and a spindle control unit 73s. The spindle motor 71s rotates the spindle which turns the workpiece. The detector 72s detects the position and rotational speed of the spindle motor 71s. The spindle control unit 73s performs the FB control of the spindle motor 71s on the basis of the command from the numerical control device 1 as well as position information and velocity information detected by the detector 72s. The spindle control unit 73s controls the rotary motion of the workpiece by performing the FB control of the spindle motor 71s. Note that the rotational speed detected by the detector 72s corresponds to the rotational speed of the spindle motor 101s.

Note that the machine tool may be one capable of machining two or more workpieces simultaneously. The machine tool capable of processing two or more workpieces simultaneously, the drive unit 7 includes two or more sets of the spindle motor 71s, the detector 72s, and the spindle control unit 73s. In this case, the machine tool is equipped with, for example, two or more tool bit holders.

The input operation unit 2 is the means by which information is entered for the control computation unit 4. The input operation unit 2 includes, for example, an input means such as a keyboard, a button, or a mouse. The input operation unit 2 accepts, for example, an input of a command, an input of a machining program number, and an input of a parameter related to the vibration cutting from an operator to the numerical control device 1 and enters them into the control computation unit 4.

The output unit 3 is the means by which information from the control computation unit 4 is outputted. The output unit 3 includes a display means such as a liquid crystal display device. The output unit 3 displays the information processed by the control computation unit 4 on its display screen. Note that it is assumed that the present embodiment includes, but is not limited to, a display means as the output unit 3. For example, when the numerical control device 1 is connected to a network, the output unit 3 may be a display device or a display device of a computer connected to the network. The output unit 3 may also be an audio device such as a speaker.

The control computation unit 4 includes an input control unit 41, a data setting unit 42, a storage unit 43, an output control unit 44, an analysis processing unit 45, a control signal processing unit 46, a programmable logic controller (PLC) circuit unit 47, an interpolation processing unit 48, an acceleration/deceleration processing unit 49, and an axis data input/output unit 50. Note that it is assumed in the present embodiment that the PLC circuit unit 47 is placed inside the control computation unit 4, but the PLC circuit unit 47 may be placed outside the control computation unit 4.

The input control unit 41 accepts information entered by the input operation unit 2. The data setting unit 42 stores the information accepted by the input control unit 41 in the storage unit 43. That is, the input information accepted by the input operation unit 2 is written to the storage unit 43 via the input control unit 41 and the data setting unit 42.

The storage unit 43 includes a parameter storage area 431, a machining program storage area 432, a display data storage area 433, and a shared area 434.

Within the parameter storage area 431 are stored the parameters used in the processing of the control computation unit 4, specifically, control parameters, servo parameters, tool bit data, and parameters related to the vibration cutting for operating the numerical control device 1.

Within the machining program storage area 432 is stored a machining program which includes one or more blocks to be used for processing of the workpiece. Note that in the present embodiment, the machining program includes commands such as a move command to move the tool bit and a rotation command to rotate the spindle.

Within the display data storage area 433 is stored screen display data to be displayed by the output unit 3. The screen display data is data for displaying information by the output unit 3. Within the shared area 434 is stored data which is temporarily used by the control computation unit 4 to perform each of various process. For example, the machining program number accepted by the input operation unit 2 is written in the shared area 434 of the storage unit 43 via the input control unit 41 and the data setting unit 42.

The output control unit 44 displays the screen display data stored in the display data storage area 433 of the storage unit 43 by the output unit 3.

In the control computation unit 4, the analysis processing unit 45, the control signal processing unit 46, and the interpolation processing unit 48 are connected to each other via the storage unit 43, through which the information is written and read out between them. In the following, when explaining the writing and reading of the information between the analysis processing unit 45, the control signal processing unit 46, and the interpolation processing unit 48, the fact that such writing and reading are performed via the storage unit 43 may be omitted from time to time.

The analysis processing unit 45 is connected to the storage unit 43. The analysis processing unit 45 keeps referring to the machining program numbers written in the shared area 434 of the storage unit 43 to accept a selected machining program number stored in the shared area 434 from the shared area 434 and reads out the selected machining program from the machining program storage area 432 to perform analysis processing for each of the blocks (each line) of the machining program. The analysis processing unit 45 analyzes codes such as an S code, which is a command for rotational speed of the spindle motor, a G code, which is a command for shaft movement, etc., and a M code, which is a command for machine movement. When finishing the analysis processing for each line of the machining program, the analysis processing unit 45 writes the analysis results of the S code, the G code, and the M code, etc. in the shared area 434 of the storage unit 43.

When the machining program includes an S code, the analysis processing unit 45 obtains the rotational speed of the spindle, which is revolutions of the spindle, by analyzing the S code. The analysis processing unit 45 then writes the obtained rotational speed of the spindle in the shared area 434 of the storage unit 43.

When the machining program includes a G code, the analysis processing unit 45 obtains movement conditions, which are the feed conditions for the tool bit to move to the machining position, by analyzing the G code. The movement conditions are specified by parameters such as the X-axis and Z-axis velocities at which the tool bit holder is to be moved, and the X-axis and Z-axis positions to which the tool bit holder is to be moved. The analysis processing unit 45 then writes the obtained movement conditions in the shared area 434 of the storage unit 43.

When the machining program includes a G code of the vibration cutting, the analysis processing unit 45 obtains a vibration frequency, which is the frequency to vibrate the tool bit in the vibration cutting, and vibration conditions, which include an amplitude to vibrate the tool bit in the vibration cutting, by analyzing the G code. The analysis processing unit 45 then writes the obtained vibration conditions in the shared area 434 of the storage unit 43.

The control signal processing unit 46, connected to the PLC circuit unit 47, accepts signal information for relays, etc. to operate the components of the machine tool from the PLC circuit unit 47. The control signal processing unit 46 writes the accepted signal information in the shared area 434 of the storage unit 43. The signal information is referred to by the interpolation processing unit 48 during processing operations. When an auxiliary command is outputted to the shared area 434 by the analysis processing unit 45, the control signal processing unit 46 reads out the auxiliary command from the shared area 434 and transmits it to the PLC circuit unit 47. The auxiliary command is a command other than the commands to move a drive axis, which is a numerically controlled axis. The auxiliary command is, for example, an M code or a T code.

The interpolation processing unit 48 is connected to the storage unit 43 and the acceleration/deceleration processing unit 49. The interpolation processing unit 48 keeps referring to the shared area 434 of the storage unit 43. When the movement conditions and the vibration conditions are written in the shared area 434 by the analysis processing unit 45, the interpolation processing unit 48 reads out the movement conditions and the vibration conditions to generate a commanded X-axis vibration movement amount, which is a commanded vibration movement amount in the X-axis direction, and a commanded Z-axis vibration movement amount, which is a commanded vibration movement amount in the Z-axis direction, by using the read-out movement conditions and vibration conditions. The commanded X-axis vibration movement amount and the commanded Z-axis vibration movement amount are also collectively referred to as simply the commanded vibration movement amounts. The interpolation processing unit 48 writes the generated commanded vibration movement amounts in the shared area 434 of the storage unit 43 and outputs them to the acceleration/deceleration processing unit 49. Upon obtaining the FB vibration movement amount from the acceleration/deceleration processing unit 49, the interpolation processing unit 48 writes the obtained FB vibration movement amount in the shared area 434 of the storage unit 43.

The acceleration/deceleration processing unit 49 is connected to the interpolation processing unit 48 and the axis data input/output unit 50. The acceleration/deceleration processing unit 49 converts the commanded vibration movement amounts outputted from the interpolation processing unit 48 into the move command per unit time factoring in acceleration/deceleration in accordance with a pre-specified acceleration/deceleration pattern, and outputs the converted move command to the axis data input/output unit 50. The acceleration/deceleration processing unit 49 also outputs the FB vibration movement amount, outputted from the axis data input/output unit 50, to the interpolation processing unit 48.

The axis data input/output unit 50 is connected to the acceleration/deceleration processing unit 49 and the drive unit 7. The axis data input/output unit 50 outputs the move command per unit time, outputted from the acceleration/deceleration processing unit 49, to the drive unit 7. The axis data input/output unit 50 also outputs the FB vibration movement amount, outputted from the drive unit 7, to the acceleration/deceleration processing unit 49.

Next, an implementation example of a brake device will be described. In the present embodiment, it is assumed that the X-axis servo motor 71x which moves the tool bit in the X-axis direction, i.e. the vertical direction, includes a brake device. The brake device of the X-axis servo motor 71x may be either built-in or external for the X-axis servo motor 71x. The brake device may be provided in a servo motor other than the X-axis servo motor 71x. For example, a servo motor capable of controlling the tool bit to move in a direction including a vertical component is equipped with a brake device.

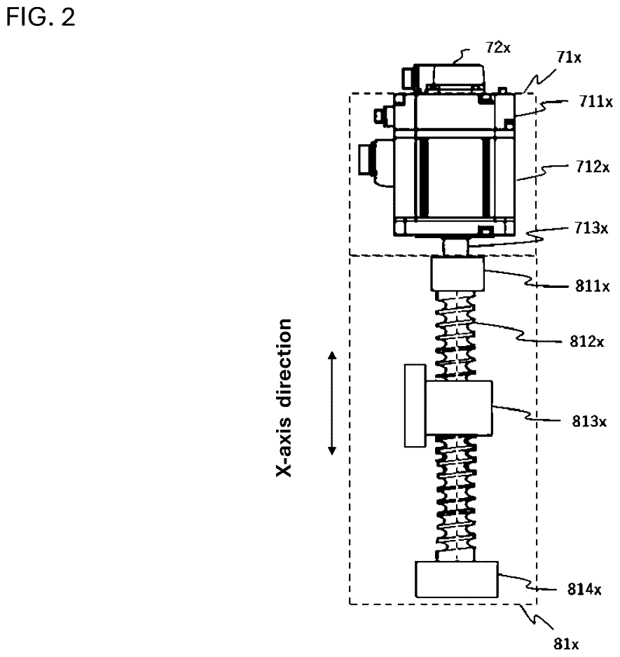

FIG. 2 illustrates an implementation example of the brake device according to the embodiment. According to FIG. 2, the X-axis servo motor 71x includes a brake device 711x, a motor body 712x, and a shaft 713x. Note that the detector 72x is provided to the X-axis servo motor 71x. The X-axis direction shown in FIG. 2 represents, for example, the vertical direction.

According to FIG. 2, the X-axis servo motor 71x is connected to a feed mechanism 81x. The feed mechanism 81x includes a coupling 811x, a ball screw 812x, a slider 813x, and a ball screw support 814x. The coupling 811x functions as a joint between the X-axis servo motor 71x and the feed mechanism 81x. The ball screw 812x, for example, is arranged along the X-axis direction and can be rotated about the X axis line via the coupling 811x by the rotation of the X-axis servo motor 71x. The slider 813x can be moved in the direction along the X axis, e.g., up and down along the vertical direction, by the rotation of the ball screw 812x.

In the event of a sudden stop of the machine tool due to an emergency or other reasons, the brake device 711x operates to stop the rotation of the motor body 712x. At this time, the rotation of the ball screw 812x stops, which also stops the vertical movement of the slider 813x.

Note that the brake device 711x may be incorporated into the ball screw support 814x rather than on the side of the motor body 712x. In the above description, the X-axis was assumed to be to the vertical direction. However, if a machine tool is used where the processing is performed with the X-axis set at an angle to the vertical direction, the brake device may be incorporated into the servo motor attached to the machine tool. If another axis different from the X axis is set to include the vertical direction, the brake device may be incorporated into the servo motor which controls the other axis. Specifically, for example, if the Y axis is set to include the vertical direction, the brake device may be incorporated into the servo motor which controls the Y axis.

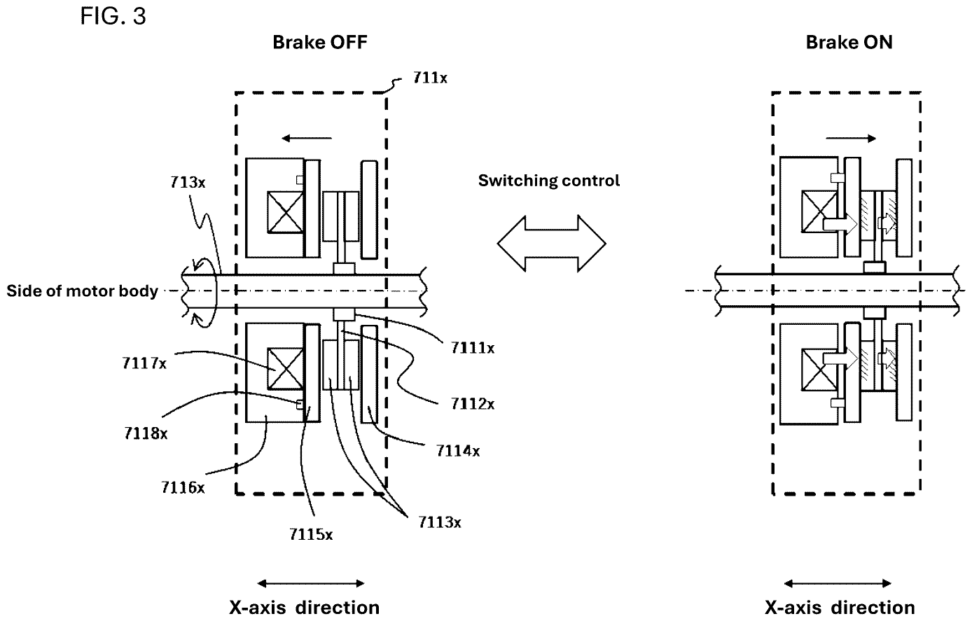

Next, an operation of the brake device with a fastening hub will be described. FIG. 3 illustrates the operation of the brake device according to the embodiment. FIG. 3 describes the operation of the brake device 711x when the brake is on and when the brake is off with reference to an example of a schematic and cross-sectional structure parallel to the X-axis direction of the brake device. In FIG. 3, the configurations other than those necessary for the description are omitted.

The brake device 711x, shown in FIG. 3, includes an external gear 7111x, an internal gear 7112x, friction plates 7113x, a fixed plate 7114x, a pressing plate 7115x, a housing 7116x, an electromagnetic coil 7117x, and a spring 7118x. The external gear 7111x and the internal gear 7112x are examples of the fastening hub claimed in CLAIMS.

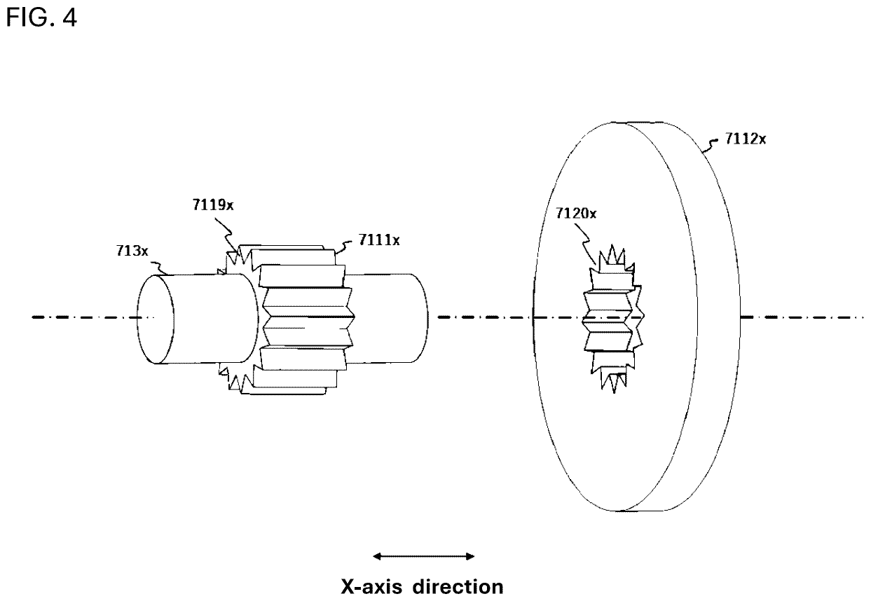

The external gear 7111x meshes with the internal gear 7112x. The specific relationship between the external gear 7111x and the internal gear 7112x will be described below using FIG. 4. FIG. 4 illustrates an example of a structure of the fastening hub of the brake device according to the embodiment.

According to FIG. 4, for example, a through hole is provided in the external gear 7111x, and the shaft 713x is inserted and fixed in the through hole. The external gear 7111x rotates about the axis of the shaft 713x in synchronization with the rotation of the shaft 713x.

The external gear 7111x is provided with a plurality of external teeth 7119x along its outer perimeter. The internal gear 7112x is provided with a plurality of internal teeth 7120x along its inner perimeter. When using the brake device 711x, the external gear 7111x and the internal gear 7112x are placed in a positional relationship such that the plurality of external teeth 7119x and the plurality of internal teeth 7120x shown in FIG. 4 mesh. At this moment, the internal gear 7112x is placed movably in the X-axis direction with respect to the external gear 7111x. When the brake is off, the internal gear 7112x rotates in synchronization with the rotation of the external gear 7111x.

A certain amount of backlash is preset by design between the external gear 7111x and the internal gear 7112x. Backlash is a gap intentionally provided where the gears mesh. For example, an optimum amount is set as the backlash in terms of operation of the pressing plate 7115x, brake specifications, ease of assembly, etc. The unit of measure for the backlash is, for example, “arcminute”.

“Arcminute” is a unit of angular size representing one-sixtieth of “a degree” or “°”. In the present embodiment, “°” will be used as the unit of measure representing the backlash.

Returning to FIG. 3, the friction plates 7113x are coupled with the internal gear 7112x. The friction plates 7113x rotate in synchronization with the rotation of the internal gear 7112x. The fixed plate 7114x functions, for example, to restrain the movement of the friction plates 7113x in the direction away from the side of the motor body 712x when the brake is switched from the OFF state to the ON state.

In FIG. 3, when the brake is off, the electromagnetic coil 7117x is excited. In other words, a current is flowing in the electromagnetic coil 7117x. At this moment, an electromagnetic force greater than the elasticity of the spring 7118x occurs to attract the pressing plate 7115x to the electromagnetic coil and moves it to the side of the motor body 712x. This places the friction plates 7113x away from the fixed plate 7114x and the housing 7116x. Then, the friction plates 7113x have no friction with the fixed plate 7114x and the housing 7116x so that there is no restraint on its rotation. Thus, the external gear 7111x can rotate in synchronization with the rotation of the internal gear 7112x, and the friction plates 7113x can rotate in synchronization with the shaft 713x.

In FIG. 3, when the brake is on, the current flowing in the electromagnetic coil 7117x is stopped to cause the electromagnetic force to disappear, and the elasticity of the spring 7118x moves the pressing plate 7115x away from the motor body 712x. This causes the friction plates 7113x to contact and be pinched between the pressing plate 7115x and the fixed plate 7114x, and the rotation of the friction plates 7113x is restrained by the friction force. Thus, the rotation of the internal gear 7112x coupled with the friction plates 7113x is restrained, and the rotation of the external gear 7111x and the shaft 713x of the motor is stopped via the gears.

When the brake is on, immediately after the X-axis servo motor 71x stops at an emergency, etc., the slider 813x, shown in FIG. 2, stops after falling by the amount of the backlash provided between the external gear 7111x and the internal gear 7112x due to the action of gravity. Thus, in an emergency stop, etc., the fall of the slider 813x can be stopped by the brake device 711x.

In normal machining, which is not the vibration cutting, the X-axis movement for the machining is made in one direction. Therefore, for example, each of the external teeth 7119x provided on the external gear 7111x, shown in FIG. 4, meshes with a pair of adjacent teeth among the plurality of internal teeth 7120x provided on the internal gear 7112x and is in contact with only one of the pair. In contrast, during the vibration cutting, because micro vibrations associated with the vibration cutting are superimposed on the movement of processing, each external tooth 7119x provided on the external gear 7111x is repeatedly in contact with both of the pair of adjacent internal teeth 7120x which mesh with the external tooth 7119x on the internal gear 7112x, for example, in a cycle of the micro vibrations associated with the vibration cutting. Therefore, the plurality of external teeth 7119x provided on the external gear 7111x and the plurality of the internal teeth 7120x provided on the internal gear 7112x wear down faster than a case where only normal processing is performed, and the end of the operating life of the brake device is reached earlier. If the servo motor continues to be used in a situation where the brake device has reached the end of its operating life, in case of an emergency stop, etc., for example, the slider 813x of the X-axis servo motor 71x may fall more than expected and collide with other mechanical structures, which may lead to failure. Therefore, the brake device needs to be replaced. Thus, in the numerical control device which allows the machine tool to execute the vibration cutting, the fastening hub of the brake device 711x, i.e., the external gear 7111x and the internal gear 7112x are more affected by the wear caused by the vibration cutting than by the wear caused by brake operation. The micro vibrations associated with the vibration cutting are vibrations based on the vibration conditions for vibrating the tool bit in the vibration cutting, which are transmitted to the brake device 711x while the vibration cutting is being executed, for example.

Returning to FIG. 1, the interpolation processing unit 48 according to the present embodiment estimates the deterioration of the brake device on the basis of the execution time of the vibration cutting. Specifically, the interpolation processing unit 48 includes a timer unit 481, an estimation unit 482, a changing unit 483, a waveform generation unit 484, and a vibration movement amount generation unit 485.

The timer unit 481 measures the execution time of the vibration cutting. Specifically, the timer unit 481 stores, for example, an accumulated value of the time during which the vibration cutting is being processed in a brake device. The timer unit 481 also determines whether the accumulated value of the execution time of the vibration cutting is greater than or equal to a predetermined value.

The estimation unit 482 estimates the deterioration of the brake device 711x on the basis of the number of cycles of the micro vibrations associated with the vibration cutting. The estimation unit 482 estimates the deterioration of the brake device 711x on the basis of, for example, the execution time of the vibration cutting measured by the timer unit 481 and the vibration frequency of the vibration cutting. The vibration frequency of the vibration cutting is, for example, a frequency which is set to generate the micro vibrations in the vibration cutting. The number of cycles of the micro vibrations associated with the vibration cutting can be calculated from the execution time of the vibration cutting and the vibration frequency of the vibration cutting. The estimation unit 482 may also regard a value obtained by counting and accumulating the number of vibration cycles on the basis of a vibration waveform being a basic waveform of the vibrations created by the waveform generation unit 484 as the number of cycles of the micro vibrations associated with the vibration cutting.

Specifically, the estimation unit 482 estimates the deterioration of the brake device 711x by referring to deterioration progression information, which shows the relationship between the execution time of the vibration cutting and the progression of the deterioration of the brake device. The deterioration progression information also includes information about the vibration frequency, which is a prerequisite for the vibration cutting. The longer the execution time of the vibration cutting is, the more the deterioration of the brake device progresses, and the deterioration progression information shows the degree of deterioration progression. The deterioration progression information is, for example, information showing the relationship between the execution time of the vibration cutting and a wear amount in the fastening hub equipped in the brake device, which, in other words, shows that the longer the execution time of the vibration cutting is, the more the wear in the fastening hub of the brake device progress. The wear amount in the fastening hub is the amount of wear which occurs, for example, between the external gear 7111x and the internal gear 7112x. The wear amount is assessed, for example, on the basis of the amount of the backlash between the external gear 7111x and the internal gear 7112x.

Note that the information showing the relationship between the execution time of the vibration cutting and the wear amount in the fastening hub of the brake device is based on, for example, measurement values obtained in advance by conducting a durability test for the vibration cutting time with respect to the brake device having the same or similar machine configuration as the brake device 711x. Specifically, the information is based on the measurement results of the backlash in the fastening hub of the brake device obtained at multiple time points along the execution time of the vibration cutting. The brake device used for the durability test may be the same type as the brake device 711x.

The vibration frequency as a precondition of the measurement is, for example, 166.7 Hz on average. The average of 166.7 Hz is achieved, for example, first by setting several vibration frequencies for the test in such a manner as: one at the vibration frequency of 166.7 Hz, at least one at the vibration frequencies less than 166.7 Hz, and at least one at the vibration frequencies greater than 166.7 Hz, and then by repeating the operation of the vibration cutting using the set vibration frequencies in steps in such a manner that the average vibration frequency of the vibration cutting executed in a predetermined time will be 166.7 Hz. Differing from the aforementioned, the measurement may be performed with the vibration frequency as the precondition of the measurement fixed at a predetermined value, e.g., 166.7 Hz. The vibration frequency as the precondition of the measurement need not be included in the deterioration progression information. In this case, the estimation unit 482 may refer to the deterioration progression information and the vibration frequency as the precondition of the measurement associated with the deterioration progression information.

The changing unit 483 changes the vibration conditions of the vibration cutting on the basis of the estimation result of the deterioration estimated by the estimation unit 482. Specifically, the changing unit 483 changes, for example, at least one of the number of cycles of vibrations per spindle rotation (count) and the spindle rotation speed (r/min) to extend the operating life of the brake device 711x, in other words, to slow the progression of deterioration of the brake device 711x. As the result, the vibration frequency (Hz) of the micro vibrations associated with the vibration cutting is changed. More specifically, for example, the changing unit 483 reduces at least one of the number of cycles of vibrations per spindle rotation (count) and the spindle rotation speed (r/min) than before the change to decrease the vibration frequency (Hz) of the micro vibrations associated with the vibration cutting.

The waveform generation unit 484 generates the vibration waveform as the basic waveform of the vibration on the basis of the information obtained from the analysis processing unit 45. When the changing unit 483 changes the vibration conditions, the waveform generation unit 484 creates a vibration waveform on the basis of the changed vibration conditions.

The vibration movement amount generation unit 485 obtains, for example, a vibration movement amount on the X axis by using the vibration waveform generated by the waveform generation unit 484 and a tool bit path. Specifically, the vibration movement amount generation unit 485 generates the vibration movement amount on the X axis by calculating, for each vibration, a vibration forward position obtained by adding an amplitude of the vibration waveform to a tool bit path position, and a vibration backward position obtained by subtracting the amplitude of the vibration waveform from the tool bit path position.

The vibration movement amount generated by the vibration movement amount generation unit 485 is sent to the drive unit 7 via the acceleration/deceleration processing unit 49 and the axis data input/output unit 50. The drive unit 7 executes the vibration cutting on the basis of the vibration movement amount sent from the vibration movement amount generation unit 485, for example, by controlling the X-axis servo motor 71x.

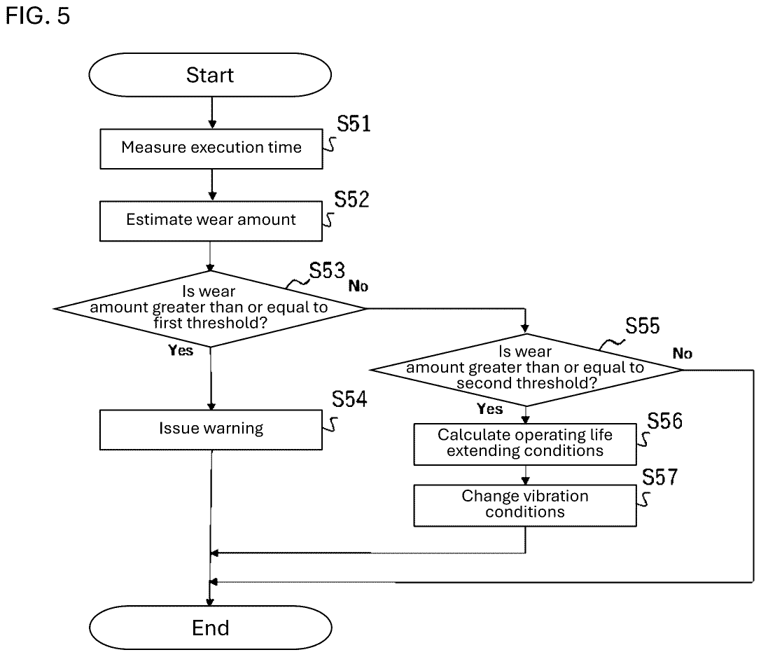

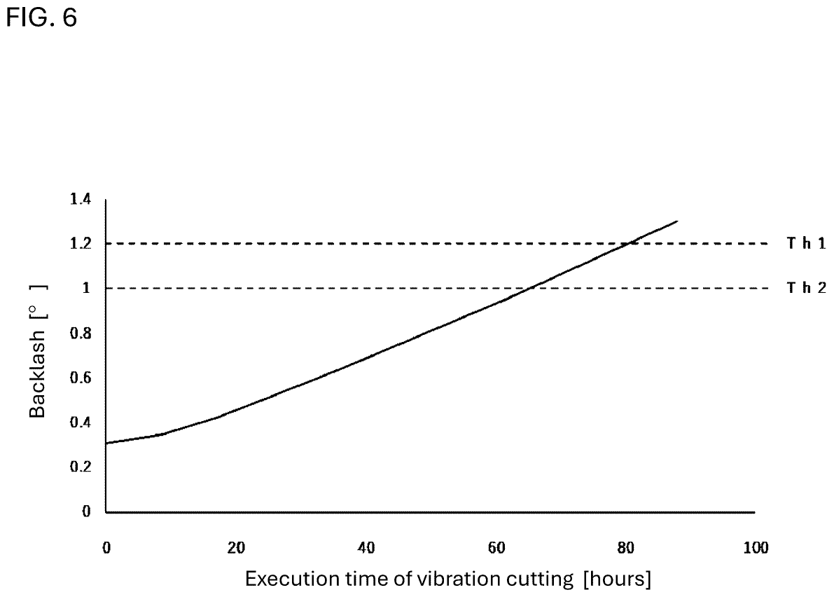

The process performed by the numerical control device 1 configured as described above will be described using FIGS. 5 and 6. FIG. 5 shows an example of the process performed by the numerical control device according to the embodiment. In the present embodiment, it is assumed that the vibration frequency of the vibration cutting before the change is 166.7 Hz. It is also assumed that the vibration frequency of the vibration cutting as the precondition of the information showing the relationship between the execution time of the vibration cutting and the wear amount in the fastening hub of the brake device, referred to by the estimation unit 482, is 166.7 Hz on average.

According to FIG. 5, when the vibration cutting processing is started, the timer unit 481 starts measurement of the execution time of the vibration cutting (Step S51). Specifically, for example, upon receiving a command to start cutting while the vibration cutting mode is ON, the timer unit 481 starts the measurement of the execution time of the vibration cutting. When the vibration cutting processing is ended, the timer unit 481 ends the measurement of the execution time of the vibration cutting. Specifically, for example, upon receiving a command to end cutting while the vibration cutting mode is ON, the timer unit 481 ends the measurement of the execution time of the vibration cutting. At this moment, the timer unit 481 adds the time measured in Step S1 to the accumulated time of the execution time which has been measured in the past and stores the result as a new accumulated time of the execution time.

When the timer unit 481 ends the measurement of the execution time of the vibration cutting, the estimation unit 482 estimates the deterioration of the brake device 711x on the basis of the execution time of the vibration cutting measured by the timer unit 481 and the vibration frequency of the vibration cutting (Step S52). Specifically, for example, the estimation unit 482 refers to the deterioration progression information to estimate the deterioration of the brake device 711x. For example, the estimation unit 482 estimates the deterioration of the brake device 711x on the basis of the information showing the relationship between the execution time of the vibration cutting and the wear amount in the fastening hub of the brake device.

FIG. 6 illustrates an example of the information showing the relationship between the execution time of the vibration cutting and the wear amount in the fastening hub of the brake device according to the embodiment. As for the information shown in FIG. 6, it is assumed that the vibration frequency as the precondition of the measurement is 166.7 Hz on average. FIG. 6 shows that the backlash, to be specific, the backlash between the external gear 7111x and the internal gear 7112x increases as the execution time of the vibration cutting increases. The estimation unit 482 estimates the wear amount in the fastening hub of the brake device 711x by referring to the information showing the relationship between the execution time of the vibration cutting and the wear amount in the fastening hub and obtaining the backlash corresponding to the execution time of the vibration cutting measured by the timer unit 481. The graph in FIG. 6 shows the relationship between the execution time of the vibration cutting and the wear amount in the fastening hub of the brake device in the case where the vibration cutting processing continues at 166.7 Hz on average, during which the execution time of the vibration cutting and the number of cycles of the micro vibrations associated with the vibration cutting are approximately proportional. Therefore, the estimation unit 482 may use the information showing the relationship between the number of cycles of the micro vibrations associated with the vibration cutting, which is calculated from the average vibration frequency and the execution time of the vibration cutting, and the wear amount in the fastening hub of the brake device as the information to estimate the wear amount in the fastening hub of the brake device 711x.

It is also appropriate to measure the relationship between the execution time of the vibration cutting and the backlash in advance for each of machine tools configurations, since the relationship depends on the conditions such as the shaft diameter of the servo motor, the ball screw diameter, and the slider inertia.

In FIG. 5, after estimating the wear amount of the fastening hub of the brake device 711x, the estimation unit 482 determines whether the estimated wear amount is greater than or equal to a first threshold (Step S53). In FIG. 6, the first threshold is, for example, Th1. For example, the threshold Th1 is set as the threshold at which the brake device needs to be replaced.

In FIG. 5, when determining that the estimated wear amount is greater than or equal to the first threshold (Yes in Step S53), the estimation unit 482 outputs, for example, a warning display to the output unit 3 via the output control unit 44 (Step S54).

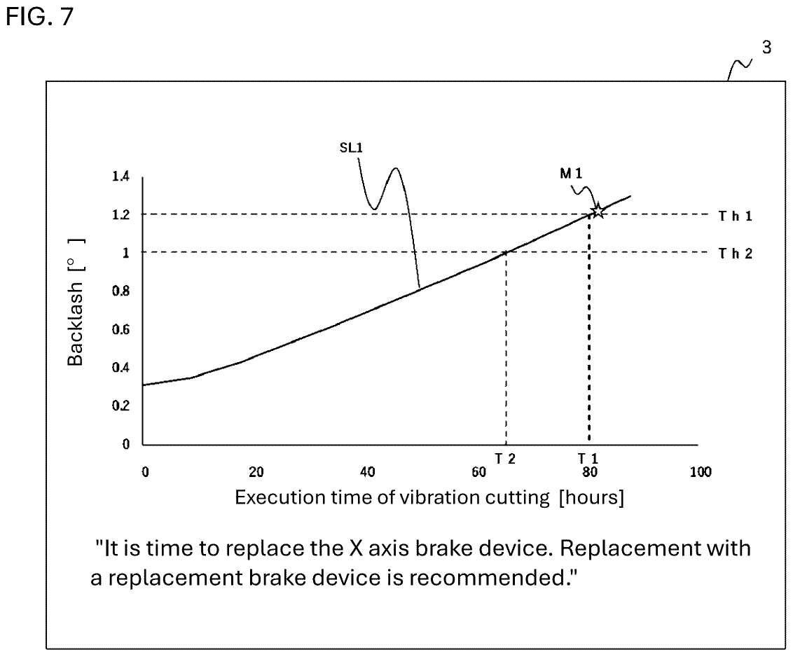

FIG. 7 shows an example of a screen display outputted by the numerical control device according to the embodiment. In FIG. 7, a message prompting replacement of the brake device 711x is displayed on the output unit 3. Specifically, in FIG. 7, the estimation unit 482 displays, on the output unit 3 via the output control unit 44, for example, the graph SL1 showing the relationship between the execution time of the vibration cutting executed with the brake device 711x incorporated and the backlash as well as the mark M1 showing the data point of the combination of the execution time of the vibration cutting at the time of the message output and the amount of the backlash corresponding to the execution time of the vibration cutting.

Here, the execution time of the vibration cutting indicated by the mark M1 in FIG. 7 is greater than or equal to T1. The amount of the backlash indicated by the mark M1 in FIG. 7 is greater than or equal to the first threshold Th1. The mark M1 is not limited to the star shape shown in FIG. 7. The Mark M1 may be a circle, rectangle, triangle, or anything else as long as it is recognizable to the operator or maintenance personnel.

Also, in FIG. 7, the estimation unit 482 displays a message, “It is time to replace the X axis brake device. Replacement with a replacement brake device is recommended.” as a prompt to replace the brake device 711x on the output unit 3 via the output control unit 44.

This allows the operator or maintenance personnel to recognize an arrival of the replacement time in the brake device and to replace the brake device on the target axis. The parallel display of the graph along with the message prompting the replacement allows the operator or maintenance In FIG. 7, the estimation unit 482 displays both the graph and the message prompting the replacement, but only the message prompting the replacement may be displayed.

When the estimation unit 482 determines that the estimated wear amount is neither greater than nor equal to the first threshold (No in Step S53), it determines whether the estimated wear amount is not less than a second threshold (Step S55). In FIG. 6, the second threshold is, for example, Th2. This threshold Th2 is set as the threshold indicating, for example, when to change the vibration conditions to extend the operating life of the brake device. Th2 is, for example, a value set in advance to the numerical control device when the machine tool is designed. Th2 may be a value, for example, set by the operator in accordance with the usage and processing status of the machine tool.

In FIG. 5, when the estimation unit 482 determines that the estimated wear amount is greater than or equal to the second threshold (Yes in Step S55), it instructs, for example, the changing unit 483 to calculate operating life extending conditions of the brake device 711x. Upon receiving the instruction to calculate the operating life extending conditions, the changing unit 483 calculates the operating life extending conditions in accordance with predetermined conditions (Step S56).

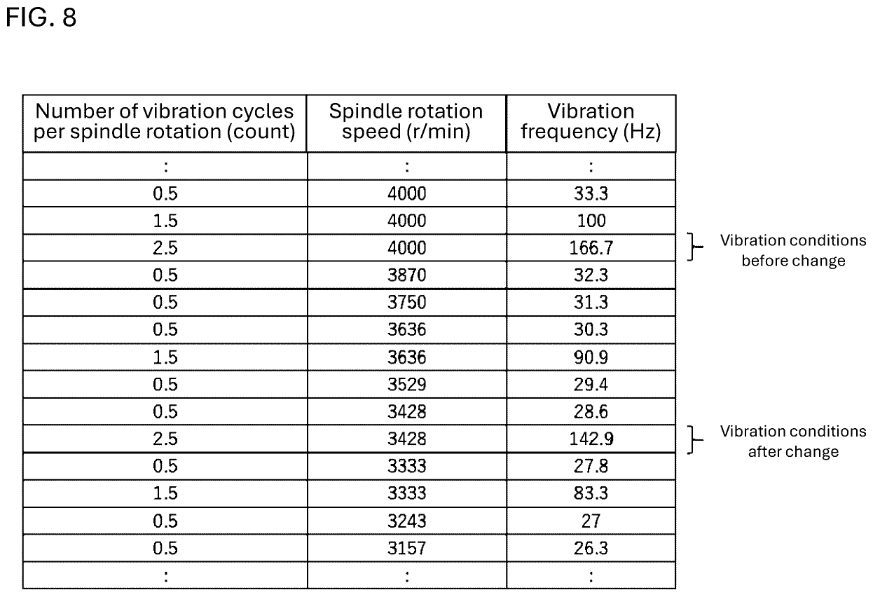

FIG. 8 shows combinations of the vibration conditions according to the embodiment. As the parameters representing the operating conditions of the vibration cutting control, in other words, the vibration conditions, FIG. 8 shows the number of cycles of vibrations per spindle rotation (count), the spindle rotation speed (r/min), and the vibration frequency (Hz). The vibration frequency is uniquely determined from the number of vibration cycles per spindle rotation and the spindle rotation speed. Therefore, the changing unit 483 changes at least one of the number of vibration cycles per spindle rotation and the spindle rotation speed so that the operating life of the brake device 711x will be extended.

In the following, specific examples of the calculation of the operating life extending conditions will be described using FIG. 8. As shown in FIG. 8, it is assumed that the vibration conditions before the change are the number of vibration cycles per spindle rotation: 2.5 times, the spindle rotation speed: 4000 r/min, and the vibration frequency: 166.7 Hz.

In FIG. 8, the changing unit 483 changes, for example, the spindle rotation speed from 4000 r/min to 3428 r/min without changing the number of vibration cycles per spindle rotation. This changes the vibration frequency from 166.7 Hz to 142.9 Hz. For example, the changing unit 483 may accept an input of a desired extended operating lifetime and change at least one of the number of vibration cycles per spindle rotation and the spindle rotation speed by calculating backward from the inputted extended operating lifetime.

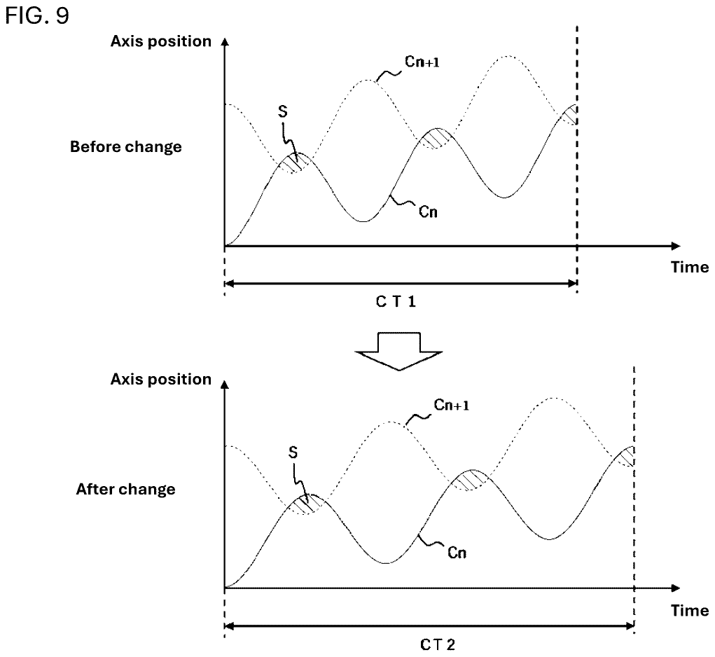

FIG. 9 is a schematic diagram showing an example of the vibration waveforms before and after the change of the vibration conditions according to the embodiment. In FIG. 9, for example, the vibration frequency before the change is 166.7 Hz and after the change is 142.9 Hz. In this case, in FIG. 9, the vibration cycle CT1 before the change is 6.0 ms and the vibration cycle CT2 after the change is 7.0 ms. FIG. 9 shows the vibration waveform Cn for the nth cycle and the vibration waveform Cn+1 for the (n+1) th cycle, which correspond to before and after the change of the vibration conditions, respectively. FIG. 9 shows air-cutting areas S occurring between the nth cycle and the (n+1) th cycle to function as the areas for breaking up chips generated in the vibration cutting before and after the change of the vibration conditions. Each of the air-cutting areas S is an area, for example, where no cutting takes place between the tool bit in the path and the workpiece, and the tool bit is just running idle, in which the cutting chips generated up to that point can be separated into pieces.

As shown in FIG. 9, it is possible to reduce the vibration frequency while generating the air-cutting areas S before and after the change of the vibration conditions if the conditions are changed as described above. This makes it possible to calculate the vibration conditions to extend the operating life of the brake device 711x while satisfying the conditions enabling the vibration cutting, that is, the conditions enabling the cutting operation while breaking up the cutting chips. Note that the vibration waveforms shown in FIG. 9 may be based on either a vibration waveform according to a command value or a vibration waveform according to an FB value as long as the vibration waveforms based on the measured values satisfy the conditions enabling the vibration cutting.

In FIG. 5, the changing unit 483 calculates the operating life extending conditions in Step S56 and changes the vibration conditions of the vibration cutting on the basis of the calculated operating life extending conditions (Step S57). The waveform generation unit 484 then creates the vibration waveform on the basis of the changed vibration conditions, and the vibration cutting processing is executed on the basis of the created vibration waveform. Then, since the vibration frequency of the vibration cutting processing is changed from 166.7 Hz to 142.9 Hz, in FIG. 4, for example, the cycle with which each external tooth 7119x on the external gear 7111x is in contact with the pair of internal teeth 7120x meshing with the external tooth on the internal gear 7112x is lengthened, so that the number of contacts per unit time during the vibration cutting can be reduced. As a specific result, the wear amount in the fastening hub of the brake device 711x per unit time while executing the vibration cutting can be reduced. In this case, the operating lifetime after the change can be expected to increase by about 1.17 times (166.7 Hz/142.9 Hz). Thus, it is possible to extend the operating life of the brake device 711x.

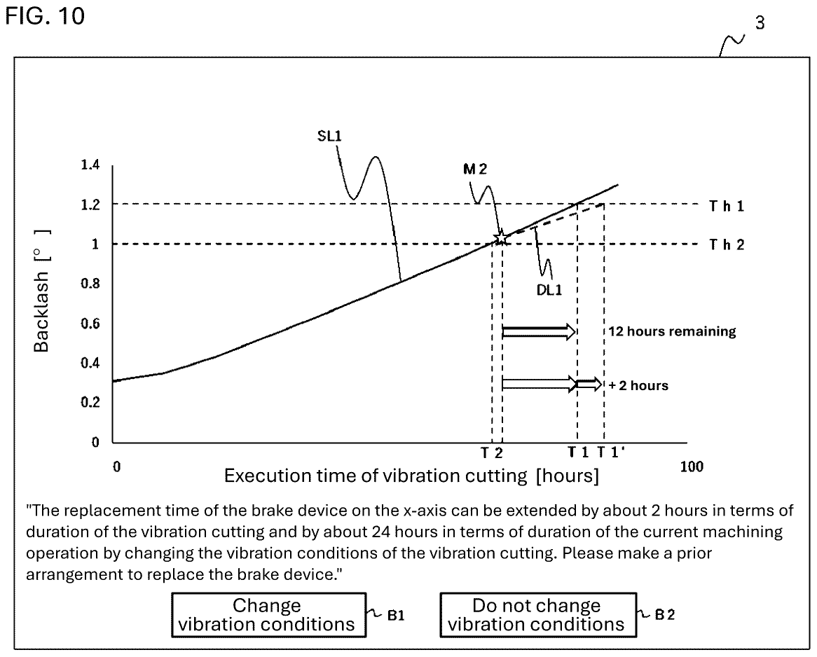

The changing unit 483 may be configured to present the calculated operating life extending conditions to the operator or maintenance personnel. FIG. 10 shows another example of the screen display outputted by the numerical control device 1 according to the embodiment. In FIG. 10, a message prompting the change of the vibration conditions in the X-axis servo motor 71x is displayed Specifically, in FIG. 10, the changing unit 483 displays, on the output unit 3 via the output control unit 44, for example, the graph showing the relationship between the execution time of the vibration cutting and the backlash in the brake device 711x as well as the mark M2 showing the combination of the execution time of the vibration cutting at the time of the message output and the amount of the backlash corresponding to the execution time of the vibration cutting. In FIG. 10, the changing unit 483 displays, for example, an estimation graph DL1 represented by a dashed line via the output control unit 44. The estimation graph DL1 is a graph showing how much the operating life can be extended if the changed vibration conditions are set at the time of the message output.

Here, the execution time of the vibration cutting indicated by the mark M2 shown in FIG. 10 is greater than or equal to T2 and less than or equal to T1. The amount of the backlash indicated by the mark M2 in FIG. 10 is greater than or equal to the second threshold Th2 and less than the first threshold Th1. The mark M2 is not limited to the star shape shown in FIG. 10. The Mark M2 may be a circle, rectangle, triangle, or anything else as long as it is recognizable to the operator or maintenance personnel.

Also, in FIG. 10, the changing unit 483 displays, on the output unit 3 via the output control unit 44, a message, “The replacement time of the brake device on the x-axis can be extended by about 2 hours in terms of duration of the vibration cutting and by about 24 hours in terms of duration of the current machining operation by changing the vibration conditions of the vibration cutting. Please make a prior arrangement to replace the brake device.” as a prompt to change the vibration conditions in the X-axis servo motor 71x. Then, the current machining operation when such a message is displayed is typically a combined machining of a normal processing and a vibration cutting processing, with a ratio of, for example, 11:1. Converting the duration of the vibration cutting to the duration of the current machining operation and showing the converted duration together with the duration of the vibration cutting make the message more understandable to the operator or maintenance personnel. In FIG. 10, the changing unit 483 also shows, for example, the operating life expectancy if the vibration conditions are not changed as an annotation of “12 hours remaining” via the output control unit 44. In FIG. 10, the changing unit 483 also shows, for example, the extended portion of the operating life expectancy which can be achieved if the vibration conditions are changed as an annotation of “+2 hours”via the output control unit 44.

This allows the operator or maintenance personnel to recognize the need to change the vibration conditions of the vibration cutting and to make a decision as to whether or not to change the vibration conditions of the vibration cutting. As a specific reaction, the operator or maintenance personnel can set the changed vibration conditions for the numerical control device 1 by pressing the button B1, shown in FIG. 10, to change the operation of the vibration cutting. The operator or maintenance personnel can choose not to set the changed vibration conditions for the numerical control device 1 to continue the vibration cutting processing with the vibration conditions before the change by pressing the button B2 not to change the vibration conditions. The parallel display of the graph along with the message prompting to change the vibration conditions allows the operator or maintenance personnel to intuitively assess the situation. Pressing the button B1 extends the operating life of the brake device 711x.

The operator or maintenance personnel may change the vibration conditions of the vibration cutting using the vibration conditions determined from the past experience about the processing conditions, instead of the vibration conditions calculated by the changing unit 483. The changing unit 483 may display, on the output unit 3 via the output control unit 44, a graph, for example, showing the remaining operating life of the brake device 711x on the basis of the vibration conditions determined by the operator or maintenance personnel. The changing unit 483 may also display the changes made in the vibration conditions via the output control unit 44. Specifically, the changing unit 483 displays, for example, the vibration conditions before the change and the vibration conditions after the change on the output unit 3. The changing unit 483 may display several vibration conditions as options after the change via the output control unit 44 and allow the operator or maintenance personnel to select one.

The second threshold Th2 is not limited to a single setting described above. Two or more second thresholds Th2 may be set. Assume the case, for example, where: two second thresholds Th21=0.8 and Th22=1.0 are set in the graph shown in FIG. 6, and the vibration conditions before the change are “the number of vibration cycles per spindle rotation: 2.5”, “the spindle rotation speed: 4000 r/min”, and “the vibration frequency: 166.7 Hz” shown in FIG. 8. Then, for example, when the estimated amount of the backlash is greater than or equal to Th21 and less than Th22, the changing unit 483 displays, on the output unit 3 via the output control unit 44, a message prompting to change the vibration conditions to “the number of vibration cycles per spindle rotation: 2.5”, “the spindle rotation speed: 3333 r/min”, and “the vibration frequency: 142.9 Hz”. After some time, when the estimated amount of the backlash is greater than or equal to Th22 and less than Th1, the changing unit 483 displays, on the output unit 3 via the output control unit 44, a message prompting to change the vibration conditions to “the number of vibration cycles per spindle rotation: 1.5”, “the spindle rotation speed: 3333 r/min”, and “the vibration frequency: 83.3 Hz”.

In this case, the changing unit 483 changes the vibration frequency from 166.7 Hz to 142.9 Hz in the first change, and changes the vibration frequency from 142.9 Hz to 83.3 Hz in the second change to further lower frequency, extending the operating lifetime more. As described above, by setting several thresholds and providing an opportunity to further change the once-changed vibration conditions, it is possible to flexibly respond to unexpected changes in operational policies, for example, when the replacement time of the brake device is changed halfway through.

In FIG. 5, when it is determined that the estimated wear amount is not greater than or equal to the second threshold (No in Step S55), the estimation unit 482 ends the process.

According to the above embodiment, the control computation unit 4 of the numerical control device 1 which causes the machine tool to execute the vibration cutting by controlling the servo motor and the brake device to brake the servo motor includes, for example, the estimation unit 482 which estimates the deterioration of the brake device 711x on the basis of the number of cycles of the micro vibrations associated with the vibration cutting.

This allows, for example, the operator or maintenance personnel to recognize in advance the replacement time, etc. of the brake device 711x by referring to the estimation result of the deterioration estimated by the estimation unit 482, and thus, to take an appropriate action before the occurrence of failure or malfunction, etc.

Thus, according to the present embodiment, it is possible to assess the deterioration of the brake device of the servo motor caused by the vibration cutting.

In FIG. 6, it is described that the values of the thresholds Th1 and Th2 are about 1.2 and 1.0, respectively, but they are not limited to these values. For example, the way the wear progresses in the fastening hub depends on the machine configurations, specifically, the shape and size, etc. of the gears which make up the fastening hub. Therefore, the thresholds Th1 and Th2 should be set optimally in accordance with the machine configurations.

The vibration frequency, which is a precondition of the graph shown in FIG. 6, is described using the case of an average of 166.7 Hz as an example, but the vibration frequency is not limited to this. For example, the same control can be performed using the information showing the relationship between the execution time of the vibration cutting executed with a smaller vibration frequency, for example, an average of 30.3 Hz, and the wear amount in the fastening hub, and as a result, the same effect can be achieved.

### Modification

The embodiment of the present disclosure has been described above. However, various modifications and applications are possible in the implementation of the present disclosure. In the embodiment above, the case is described where the change of the vibration conditions and the output of the estimation result to the operator, etc., are achieved on the basis of the estimation result of the deterioration estimated by the estimation unit 482. In the modification, the case will be described where the change of the vibration conditions and the output of the estimation result to the operator, etc., are achieved on the basis of the measurement results obtained by actually conducting a brake test in addition to the estimation result of the deterioration estimated by the estimation unit 482.

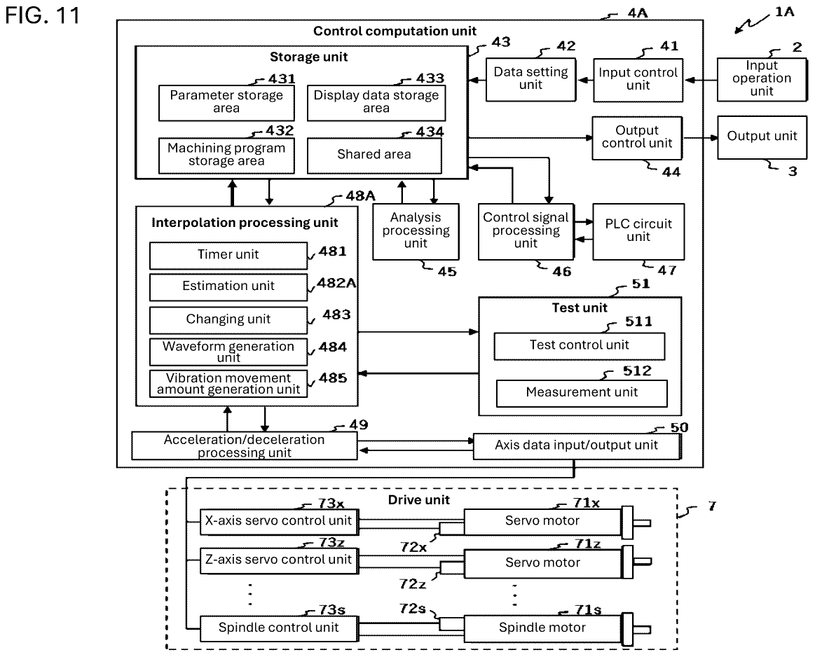

FIG. 11 shows a configuration example of a numerical control device 1A according to the modification. The numerical control device 1A includes the input operation unit 2, the output unit 3, and a control computation unit 4A. In FIG. 11, the drive unit 7 is shown as a component of the machine tool, for example. The drive unit 7 may be a separate component from the machine tool.

The control computation unit 4A according to the modification includes the input control unit 41, the data setting unit 42, the storage unit 43, the output control unit 44, the analysis processing unit 45, the control signal processing unit 46, the PLC circuit unit 47, an interpolation processing unit 48A, the acceleration/deceleration processing unit 49, the axis data input/output unit 50, and a test unit 51.

The input control unit 41, the data setting unit 42, the storage unit 43, the output control unit 44, the analysis processing unit 45, the control signal processing unit 46, the PLC circuit unit 47, the acceleration/deceleration processing unit 49, and the axis data input/output unit 50 are the same as those in the embodiment described above and are therefore omitted in the following description.

The interpolation processing unit 48A according to the modification includes the timer unit 481, an estimation unit 482A, the changing unit 483, the waveform generation unit 484, and the vibration movement amount generation unit 485. The timer unit 481, the changing unit 483, the waveform generation unit 484, and the vibration movement amount generation unit 485 are the same as those in the embodiment above and are therefore omitted in the following description.

The estimation unit 482A according to the modification has the function of determining whether or not to conduct the brake test on the basis of the estimated wear amount in addition to the functions the estimation unit 482 according to the embodiment described above has.

The test unit 51 conducts the brake test. The test unit 51 conducts the brake test upon receiving an instruction to do so from the estimation unit 482 of the interpolation processing unit 48, for example. Specifically, the test unit 51 includes a test control unit 511 and a measurement unit 512.

The test control unit 511 controls the brake test. Specifically, upon receiving the instruction to conduct the brake test from the estimation unit 482, for example, the test control unit 511 switches the brake of the brake device 711x of the X-axis servo motor 71x from the OFF state to the ON state. At this time, for example, the test control unit 511 switches the brake of the brake device 711x from the OFF state to the ON state after verifying the issuance of the command to stop the rotation of the X-axis servo motor 71x.

The measurement unit 512 measures, for example, the backlash in the fastening hub of the brake device 711x. Specifically, for example, the measurement unit 512 measures the amount of the backlash between the external gear 7111x and the internal gear 7112x. Since the backlash grows in proportion to the execution time of the vibration cutting, measuring the backlash allows for a more accurate assessment of the degree of deterioration.

When the brake is switched from the OFF state to the ON state by the test control unit 511, the measurement unit 512 calculates the difference between the value of an FB counter in the FB control of the detector 72x at the moment when an ON command is issued to the brake and the value of the FB counter at the moment when the rotation of the X-axis servo motor 71x is completely stopped by the brake being turned ON, that is, at the moment when the counter value no longer changes. The value of the FB counter is transmitted, for example, from the detector 72x to the measurement unit 512 via the X-axis servo control unit 73x, the axis data input/output unit 50, the acceleration/deceleration processing unit 49, and the interpolation processing unit 48.

The measurement unit 512 calculates the rotation angle of the fastening hub when the X-axis servo motor 71x is braked as the backlash by dividing the calculated difference value by the value of the FB counter per rotation. The measurement unit 512 transmits the calculated amount of the backlash to, for example, the estimation unit 482A.

The amount of the backlash to be calculated may vary depending on, for example, the relative positional relationship at the moment when the brake is turned on between the external teeth 7119x of the external gear 7111x and the internal teeth 7120x of the internal gear 7112x in the X-axis servo motor 71x. Therefore, it is appropriate for the test unit 51 to conduct the brake tests multiple times to calculate the average value or the maximum value of the backlash amounts obtained in each test as the new value of the backlash amount. If the gear ratio between the gear on the side of the motor shaft and the gear on the side of the brake device which meshes with the former is not 1:1, it is appropriate to calculate the backlash by also considering the gear ratio.

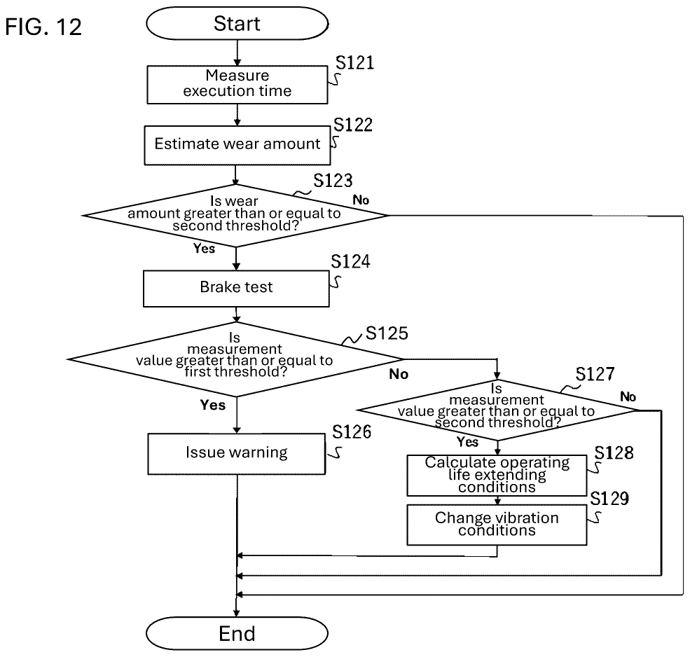

The process performed by the numerical control device 1A, configured as described above, will be described using FIG. 12 and FIG. 6. FIG. 12 shows an example of the process performed by the numerical control device 1A according to the modification.

In FIG. 12, Step S121 and Step S122 Are the Same As Step S51 and Step S52 Shown in FIG. 5.

In FIG. 12, the estimation unit 482A estimates the wear amount in the fastening hub of the brake device 711x and determines whether the estimated wear amount is greater than or equal to the second threshold (Step S123). Here, the second threshold is, for example, Th2 shown in FIG. 6.

In FIG. 12, when the estimation unit 482A determines that the estimated wear amount is greater than or equal to the second threshold (Yes in Step S123), for example, it instructs the test unit 51 to conduct the brake test. Upon receiving the instruction from the estimation unit 482A, the test unit 51 conducts the brake test (Step S124).

Specifically, upon receiving the instruction to conduct the brake test from the estimation unit 482, the test control unit 511 switches, for example, the brake of the brake device 711x of the X-axis servo motor 71x from the OFF state to the ON state.

When the brake is switched from OFF to ON by the test control unit 511, the measurement unit 512 calculates the difference between the value of the FB counter in the FB control of the detector 72x at the moment when the brake is turned ON and the value of the FB counter at the moment when the rotation of the X-axis servo motor 71x is stopped by the brake turned ON. The measurement unit 512 calculates the rotation angle of the fastening hub when the X-axis servo motor 71x is braked as the backlash by dividing the calculated difference value by the value of the FB counter per rotation. The measurement unit 512 transmits the calculated amount of the backlash to, for example, the estimation unit 482A as the measurement value of the brake test.

In FIG. 12, upon receiving the measurement value of the brake test from the measurement unit 512, the estimation unit 482A determines whether the received measurement value of the brake test is greater than or equal to the first threshold (Step S125). Here, the first threshold is, for example, Th1 shown in FIG. 6.

In FIG. 12, when determining that the measurement value of the brake test is greater than or equal to the first threshold (Yes in Step S125), the estimation unit 482A outputs, for example, the warning display to the output unit 3 via the output control unit 44 (Step S126). The manner of the output is the same as in the embodiment described above.

When determining that the measurement value of the brake test is not greater than or equal to the first threshold (No in Step S125), the estimation unit 482A determines whether the measurement value of the brake test is greater than or equal to the second threshold (Step S127). Here, the second threshold is, for example, Th2 shown in FIG. 6.

In FIG. 12, when determining that the measurement value of the brake test is greater than or equal to the second threshold (Yes in Step S127), the estimation unit 482A instructs, for example, the changing unit 483 to calculate the operating life extending conditions of the brake device 711x. Upon receiving the instruction to calculate the operating life extending conditions, the changing unit 483 calculates the operating life extending conditions in accordance with predetermined conditions (Step S128). The calculation method of the operating life extending conditions is the same as that in the embodiment described above.

In FIG. 12, Step S129 is the same as step S57 shown in FIG. 5.

In FIG. 12, when it is determined that the estimated wear amount is not greater than or equal to the second threshold (No in Step S123), the estimation unit 482A ends the process. In FIG. 12, when it is determined that the measurement value of the brake test is not greater than or equal to the second threshold (No in Step S127), the estimation unit 482A ends the process.

According to the modification, the control computation unit 4A of the numerical control device 1A which causes the machine tool to execute the vibration cutting by controlling the servo motor having the brake device further includes, for example, the test unit 51 which conducts the brake test of the brake device 711x in addition to the estimation unit 482A which estimates the deterioration of the brake device 711x on the basis of the execution time of the vibration cutting. The control computation unit 4A estimates the deterioration of the brake device on the basis of the estimation result of the deterioration estimated on the basis of the execution time of the vibration cutting as well as the result of the brake test. This allows for a more accurate estimation of the deterioration of the brake device 711x. In addition, since the brake test only needs to be performed when specified requirements are met, it is possible to minimize machine downtime due to the brake test.

### Alternative Embodiment

In the embodiment above, the estimation unit 482 estimates the deterioration of the brake device by estimating the wear amount in, but not limited to, the fastening hub of the brake device on the basis of the execution time of the vibration cutting. The component to be used as the deterioration indicator may be any component of the brake device as long as it deteriorates over the execution time of the vibration cutting and its deterioration can be assessed. For example, the estimation unit 482 may estimate the deterioration of the brake device by estimating the wear amount of the friction plates of the brake device.

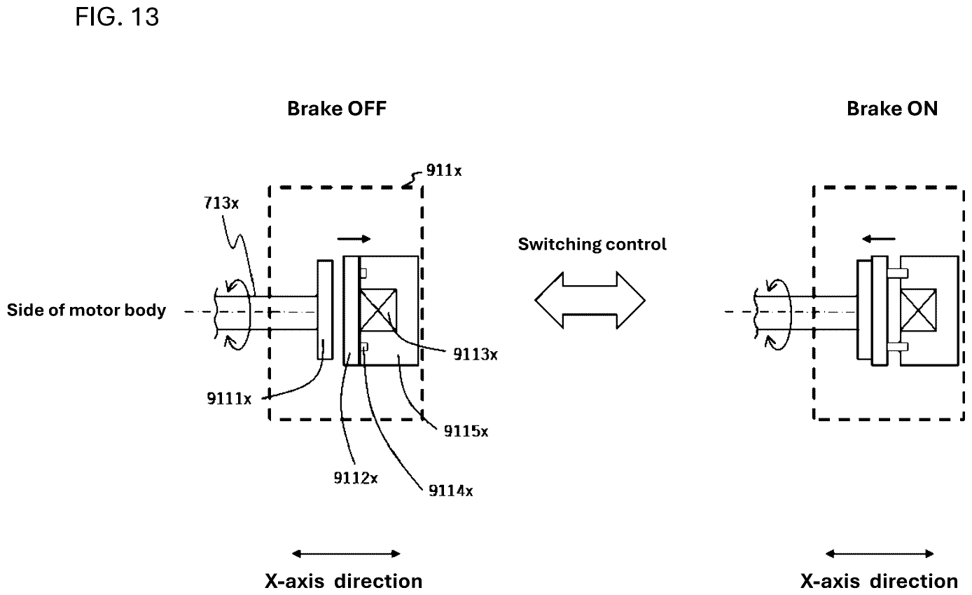

FIG. 13 illustrates the operation of the brake device according to the alternative embodiment. In FIG. 13, the operation of the brake device when the brake is turned on and when the brake is turned off will be described with reference to an example of a schematic cross-sectional structure parallel to the X-axis direction of a brake device 911x corresponding to the brake device 711x shown in FIG. 3 in the embodiment described above. In FIG. 3, configurations other than those necessary for the description are omitted.

The brake device 911x shown in FIG. 13 is a type of brake device without the fastening hub, unlike a type of brake device with the fastening hub shown in FIG. 3. The brake device 911x includes a friction plate 9111x, a pressing plate 9112x, an electromagnetic coil 9113x, a spring 9114x, and a housing 9115x. The friction plate 9111x is fixed to the shaft 713x and rotates with the rotation of the shaft 713x.

In FIG. 13, when the brake is off, the electromagnetic coil 9113x is excited. In other words, a current is flowing in the electromagnetic coil 9113x. At this moment, an electromagnetic force greater than the elasticity of the spring 9114x occurs to attract the pressing plate 9112x to the electromagnetic coil and moves it to the opposite side of the motor body 712x. This places the friction plate 9111x away from the pressing plate 9112x. Then, the friction plate 9111x has no friction with the pressing plate 9112x, so that there is no restraint on its rotation. Thus, the friction plate 9111x rotates with the rotation of the shaft 713x.

In FIG. 13, when the brake is on, the current flowing in the electromagnetic coil 9113x is stopped to cause the electromagnetic force to disappear, and the elasticity of the spring 9114x moves the pressing plate 9112x closer the motor body 712x. This brings the friction plate 9111x into contact with the pressing plate 9112x, and the rotation of the friction plate 9111x is restrained by the friction force. Thus, the rotation of the shaft 713x with the friction plate 9111x fixed stops.

In the numerical control device which allows the machine tool to execute the vibration cutting, the friction plate 9111x of the brake device 911x is a component which wears down more by the vibration cutting than by the brake operation, similarly to the fastening hub of the brake device 711x of a type of brake device with the fastening hub. For this reason, in the brake device 911x of a type of brake device without the fastening hub, the deterioration of the brake device 911x may be estimated by estimating the wear amount in the friction plate 9111x of the brake device 911x on the basis of the execution time of the vibration cutting.

In this case, the estimation unit 482 uses the information showing the relationship between the execution time of the vibration cutting and a pull-in time when the brake is turned off as the information showing the relationship between the execution time of the vibration cutting using the X-axis servo motor 71x and the wear amount in the friction plate 9111x of the brake device 911x. The pull-in time when the brake is turned off is, for example, the time it takes for the pressing plate 9112x to be attracted up to the electromagnetic coil 9113x after the current starts flowing by the brake being turned off in the electromagnetic coil 9113x shown in FIG. 13. As the friction plate 9111x wears down, the distance between the electromagnetic coil 9113x and the friction plate 9111x increases. As the distance between the electromagnetic coil 9113x and the friction plate 9111x increases, the pull-in current required when the brake is turned off increases. Then, a specific amount of time is needed to raise the pull-in current to a certain value, but because the certain value becomes greater, the time period from the time the brake OFF command is issued until the rotation velocity of the motor reaches a target value becomes longer. Therefore, in the brake device 911x of a type of brake device without the fastening hub, the deterioration of the friction plate 9111x becomes a bottleneck of operation, requiring the replacement of the brake device 911x.

The information showing the relationship between the execution time of the vibration cutting and the pull-in current when the brake is turned off is information based on, for example, the measurement values obtained in advance by conducting a durability test for the vibration cutting time with respect to a brake device of the same machine configuration. The estimation unit 482 estimates the deterioration of the brake device 911x on the basis of the information showing the relationship between the execution time of the vibration cutting and the pull-in time of the friction plate when the brake is turned off. The estimation unit 482 estimates the deterioration of the brake device 911x, for example, by setting the first threshold and the second threshold in the same manner as described in the embodiment above with respect to the information showing the relationship between the execution time of the vibration cutting and the pull-in time when the brake is turned off. The estimation unit 482 may be configured to conduct the brake test after the estimation is made in the same manner as described in the modification of the embodiment above.

In the embodiment above, it is described that the numerical control device 1 includes the input operation unit 2 and the output unit 3, but the configuration is not limited to this. Specifically, the input operation unit 2 or the output unit 3 may be externally attached to the numerical control device 1 to configure the numerical control device 1 without the input operation unit 2 or the output unit 3.

In the embodiment above, it is described that the numerical control device 1 executes the vibration cutting by vibrating the tool bit, but the side to be vibrated is not limited to the tool bit. For example, the numerical control device 1 may vibrate the workpiece to execute the vibration cutting.

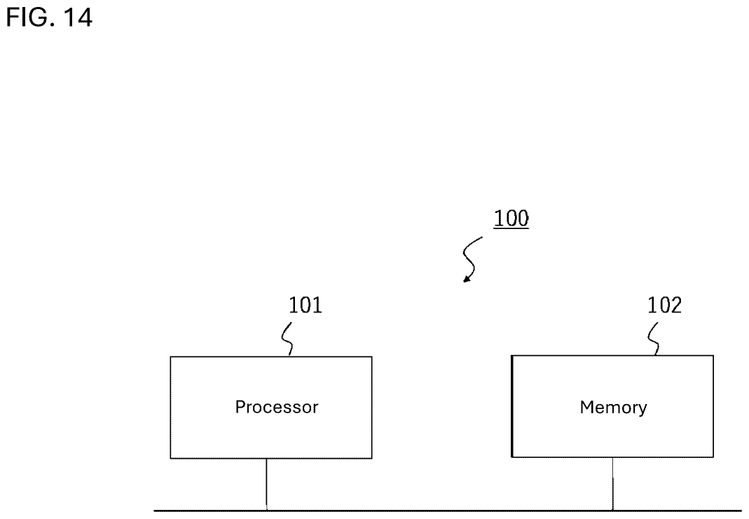

Here, hardware configurations of the control computation unit 4 of the numerical control device 1 and the control computation unit 4A of the numerical control device 1A will be described. FIG. 14 shows a hardware configuration example of the control computation unit according to the embodiment and the modification. Since the control computation units 4 and 4A have a similar hardware configuration, the hardware configuration of the control computation unit 4 will be discussed here.

The control computation unit 4 can be implemented with a control circuit 100, i.e., using a processor 101 and a memory 102 shown in FIG. 14. An example of the processor 101 is a CPU (alternatively referred to as a central processing unit, processing unit, arithmetic unit, microprocessor, microcomputer, processor, and digital signal processor (DSP)) and a system LSI (large scale integration). An example of the memory 102 is a random access memory (RAM) and a read only memory (ROM).

The control computation unit 4 is realized by the processor 101 reading and executing a program stored in the memory 102 to perform the operation of the control computation unit 4. It can also be said that the program is a recipe to cause a computer to perform the procedures or methods of the control computation unit 4. The memory 102 is also used as a temporary memory when the processor 101 performs various processes.

The program to be executed by the processor 101 may be a computer program product provided as a computer readable and non-transitory storage medium containing a plurality of commands executable for the computer to perform the data processing. When the processor 101 executes the program, the computer performs the data processing via the plurality of commands.

Alternatively, the control computation unit 4 may be implemented with dedicated hardware. The functions of the control computation unit 4 may be partially implemented with dedicated hardware and partially implemented with software or firmware.

The present disclosure allows for various embodiments and modifications without departing from the broad spirit and scope of the present disclosure. The embodiments above are intended to illustrate the present disclosure and are not intended to limit the scope of the present disclosure. In other words, the scope of the present disclosure is shown by the scope of the claims, not by the embodiments. That is, the various modifications made within the scope of the claims and within the meaning of the disclosure equivalent to the claims are considered within the scope of the present disclosure.

### INDUSTRIAL AVAILABILITY

According to the present disclosure, it is possible to provide a numerical control device capable of assessing the deterioration caused by the vibration cutting of the brake device which brakes the servo motor.

### DESCRIPTION OF SYMBOLS

1,1A . . . numerical control device,
2 . . . input operation unit,
3 . . . output unit,
4,4A . . . control computation unit,
41 . . . input control unit,
42 . . . data setting unit,
43 . . . storage unit,
44 . . . output control unit,
45 . . . analysis processing unit,
46 . . . control signal processing unit,
47 . . . PLC circuit unit,
48,48A . . . interpolation processing unit,
481 . . . timer unit,
482, 482A . . . estimation unit,
483 . . . changing unit,
484 . . . waveform generation unit,
485 . . . vibration movement amount generation unit,
49 . . . acceleration/deceleration processing unit,
50 . . . axis data input/output unit,
51 . . . test unit,
511 . . . test control unit,
512 . . . measurement unit,
7 . . . drive unit,
71x . . . X-axis servo motor,
72x . . . detector,
73x . . . X-axis servo control unit,
711x . . . brake device,
7111x . . . external gear,
7112x . . . internal gear,
7113x, 9111x . . . friction plate

1-10. (canceled)

11. A numerical control device which controls a servo motor to cause a machine tool to execute vibration cutting, the numerical control device comprising:
a processor to execute a program; and
a memory to store the program which, when executed by the processor, performs a process of
estimating deterioration of the brake device for braking the servo motor on the basis of a number of cycles of micro vibrations associated with the vibration cutting.

12. A numerical control device which controls a servo motor to cause a machine tool to execute vibration cutting, the numerical control device comprising:
a processor to execute a program; and
a memory to store the program which, when executed by the processor, performs a process of
estimating deterioration of the brake device for braking the servo motor on the basis of an execution time of the vibration cutting and a vibration frequency of the vibration cutting.

13. The numerical control device according to claim 11, wherein the program performs a process of estimating the deterioration of the brake device by referring to deterioration progression information showing relationship between the execution time of the vibration cutting and progression of the deterioration of the brake device.

14. The numerical control device according to claim 12, wherein the program performs a process of estimating the deterioration of the brake device by referring to deterioration progression information showing relationship between the execution time of the vibration cutting and progression of the deterioration of the brake device.

15. The numerical control device according to claim 11, wherein the program performs a process of estimating a wear amount in a fastening hub equipped in the brake device.

16. The numerical control device according to claim 12, wherein the program performs a process of estimating a wear amount in a fastening hub equipped in the brake device.

17. The numerical control device according to claim 11, wherein the program further performs a process of conducting a brake test of the brake device for estimating the deterioration of the brake device on the basis of the estimation result of the deterioration and a result of the brake test.

18. The numerical control device according to claim 12, wherein the program further performs a process of conducting a brake test of the brake device for estimating the deterioration of the brake device on the basis of the estimation result of the deterioration and a result of the brake test.

19. The numerical control device according to claim 11, wherein the program further performs a process of changing vibration conditions of the vibration cutting to slow progression of the deterioration of the brake device on the basis of the estimation result of the deterioration.

20. The numerical control device according to claim 12, wherein the program further performs a process of changing vibration conditions of the vibration cutting to slow progression of the deterioration of the brake device on the basis of the estimation result of the deterioration.

21. The numerical control device according to claim 19, wherein the program further performs a process of changing vibration conditions of the vibration cutting to decrease a vibration frequency of the vibration cutting on the basis of the estimation result of the deterioration.

22. The numerical control device according to claim 20, wherein the program further performs a process of changing vibration conditions of the vibration cutting to decrease the vibration frequency of the vibration cutting on the basis of the estimation result of the deterioration.

23. The numerical control device according to claim 11, wherein the program further performs a process of outputting the estimation result of the deterioration.

24. The numerical control device according to claim 12, wherein the program further performs a process of outputting the estimation result of the deterioration.

25. The numerical control device according to claim 23, wherein the program performs a process of outputting an operating life of the brake device on the basis of the estimation result of the deterioration.

26. The numerical control device according to claim 24, wherein the program performs a process of outputting an operating life of the brake device on the basis of the estimation result of the deterioration.
